(19) United States
(12) Patent Application Publication
(10) Pub. No.: US 2013/0111269 A1
(43) Pub. Date: May 2, 2013

(54) METHOD FOR ASSISTING INSPECTION

(71) Applicant: SZU-CHENG WU, Hsinchu (TW)

(72) Inventor: SZU-CHENG WU, Hsinchu (TW)

(73) Assignee: ACCTON TECHNOLOGY CORPORATION, Hsinchu (TW)

(21) Appl. No.: 13/611,143

(22) Filed: Sep. 12, 2012

(30) Foreign Application Priority Data
Oct. 28, 2011 (TW) 100139438

(51) Int. Cl. G06F 11/28

(52) U.S. Cl. 714/32; 714/E11.178

(57) ABSTRACT

An inspection method for assisting in search of a first program which causes overloading in a computer is disclosed. The method comprises: (A) setting an upper-limit variable, a lower-limit variable, and a middle variable equaling a first outcome of computation according to a formula H; (B) setting a third program with its priority index equaling the middle variable; (C) setting the upper-limit variable equaling the middle variable and then the middle variable equaling a second outcome of computation according to the formula H, if the third program is run by the computer; otherwise, setting the lower-limit variable equaling the middle variable and then the middle variable equaling the second outcome; (D) repeating the steps (B) and (C), until the difference between the upper-limit or lower-limit variable and the middle variable satisfies a first predetermined value; and (E) outputting the value of the middle variable.

### CROSS REFERENCE TO RELATED APPLICATION

The present application is based on, and claims priority from, Taiwan (International) Application Serial Number 100139438, filed on Oct. 28, 2011, the disclosure of which is hereby incorporated by reference herein in its entirety.

### TECHNICAL FIELD

The present invention relates to an assisting inspection technique, and more particularly, to an inspection method for assisting in the search of a first program which causes overloading in a computer by means of priority index.

### TECHNICAL BACKGROUND

During the process of software programming and testing for computers, the operational efficiency in the computers might be reduced remarkably due to improper designs or unintended bugs in program codes. Even more, that may cause overloading of the computers, effect the operation of their operating systems severely, and finally deadlock the computers. The reasons for the overloading can be referred to incorrect designs in program codes or breaks in computer memories, which cause infinitely cyclic repetitions to occupy whole processing resources in the computers. Once a computer is overloaded, it is in need to find out the troublemaker program and thereby to solve problems therein, especially to the computers of real-time operating system, such as VxWorks.

Conventionally, programmers try to find the troublemaker program by means of shutting down application programs one by one and then detecting the availability of processing resources in the computers or the error messages therein. It would cost a lot of time to detect and analyze the error messages to confirm which program is the troublemaker. Therefore, it is in need to develop an inspection technique for assisting in search of the troublemaker program which causes overloading in a computer.

### Technical Summary

To solve the foregoing problems, a method for assisting in search of a troublemaker program which causes overloading in a computer is provided in this disclosure. The method can extract the priority index of the suspected troublemaker program, so as to facilitate the programmers to check the program with the extracted priority first. Thus, the debugging efficiency can be improved.

According to one aspect of the present invention, an embodiment provides an inspection method for assisting in search of a first program which causes overloading in a computer, where each of to-be-run programs is set with a priority index to indicate its priority order being run by the computer, the priority index has its value in the range from M to N, the inspection method comprising the steps of: (A) providing a second program to set an upper-limit variable equaling M, a lower-limit variable equaling N, and a middle variable equaling a first outcome of computation according to a formula H=(the upper-limit variable+the lower-limit variable)/2; (B) setting, by the second program, a third program with its priority index equaling the middle variable; (C) setting, by the second program, the upper-limit variable equaling the middle variable and then the middle variable equaling a second outcome of computation according to the formula H, if the third program is run by the computer; otherwise, setting the lower-limit variable equaling the middle variable and then the middle variable equaling the second outcome; (D) repeating the steps (B) and (C), until the difference between the upper-limit or lower-limit variable and the middle variable satisfies a first predetermined value; and (E) outputting the value of the middle variable.

According to another aspect of the present invention, another embodiment provides an inspection method for assisting in search of a troublemaker program which causes overloading in a computer, where each of to-be-run programs is set with a priority index to indicate its priority order being run by the computer, the priority index has its value in the range from M to N, the inspection method comprising the steps of: (A) setting a first program with its priority index equaling M, and then letting the computer perform the first program which counts the number A of times that the first program is run by the computer in a predetermined interval; (B) setting the first program with its priority index equaling N, and then letting the computer perform the first program which counts the number B of times that the first program is run by the computer in the predetermined interval; (C) calculating the load of the computer according to a formula F including the numbers A and B; (D) providing a second program to set an upper-limit variable equaling M, a lower-limit variable equaling N, and a middle variable equaling a first outcome of computation according to a formula H=(the upper-limit variable+the lower-limit variable)/2; (E) setting, by the second program, a third program with its priority index equaling the middle variable; (F) setting, by the second program, the upper-limit variable equaling the middle variable and then the middle variable equaling a second outcome of computation according to the formula H, if the third program is run by the computer; otherwise, setting the lower-limit variable equaling the middle variable and then the middle variable equaling the second outcome; (G) repeating the steps (E) and (F), until the difference between the upper-limit or lower-limit variable and the middle variable satisfies a first predetermined value; and (H) outputting the value of the middle variable.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 shows a flowchart of an assisting inspection method according to an embodiment of the present invention

FIG. 2 shows Table I which summarizes the upper-limit, middle, and lower-limit variables calculated in the first example.

FIG. 3 shows Table II which summarizes the upper-limit, middle, and lower-limit variables calculated in the second example.

FIG. 4 shows Table III which summarizes the upper-limit, middle, and lower-limit variables calculated in another example.

FIG. 5 shows a flowchart of a load calculating method according to an embodiment of the present invention.

### DESCRIPTION OF THE EXEMPLARY EMBODIMENTS

For further understanding and recognizing the fulfilled functions and structural characteristics of the disclosure, several exemplary embodiments cooperating with detailed description are presented as the following.

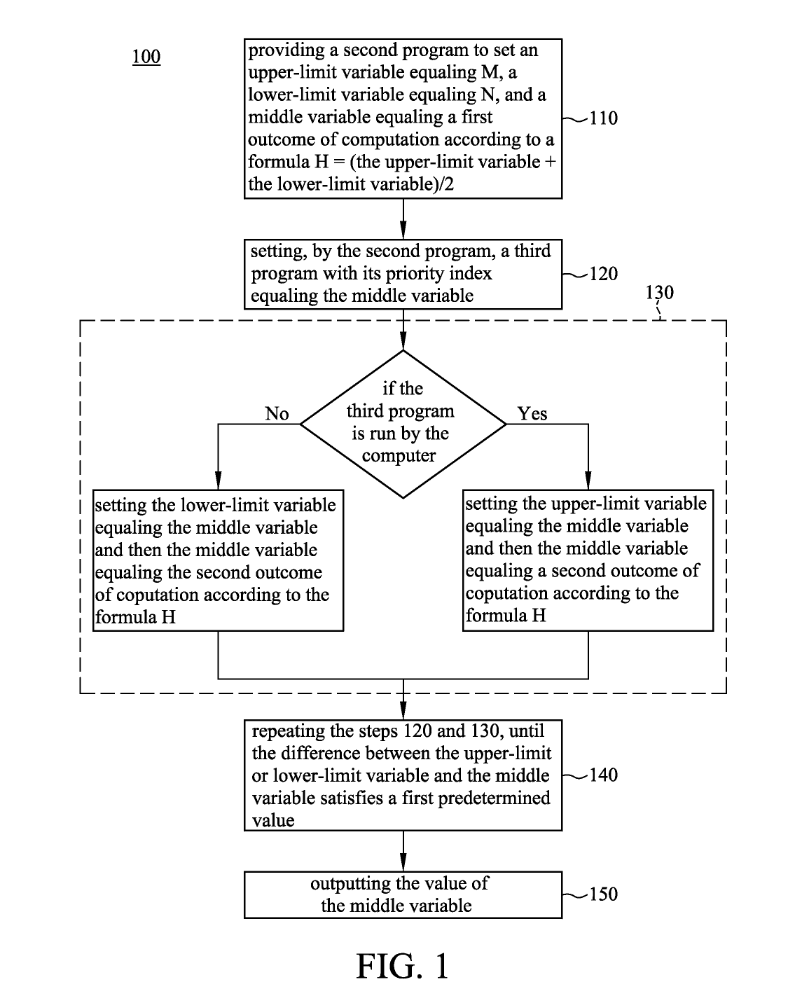

FIG. 1 shows a flowchart of an assisting inspection method according to a first embodiment of the present invention, to describe the procedures or steps of the inspection method 100 for assisting in search of a troublemaker program which causes overloading in a computer. In the embodiment, the inspection method 100 is applicable to a real-time operating system, such as VxWorks for use in embedded systems, or to other operating systems in which each of to-be-run programs is set with a priority index to indicate its priority order being run by the computer. The priority index can have its value, of either an integer or a non-integer real number, in the range from M to N. In the exemplary embodiment, M is more than N, and a program with priority index of M has higher priority than that of N. Some temporary programs may be included in the method, such as a setter program and a tester program. The setter program is configured to set the priority index of the tester program, and upper-limit, middle, and lower-limit variables in the setter program, so as to facilitate the inspection method 100 in finding out the priority-index value of the troublemaker program. For sake of convenience in describing the embodiment, the troublemaker, setter, and tester programs are also referred to as “first program”, “second program”, and “third program”, respectively.

Please referring to FIG. 1, the inspection method 100 includes the following steps. In step 110, the second program is provided to set an upper-limit variable equaling M, a lower-limit variable equaling N, and a middle variable equaling a first outcome of computation according to a formula H=(the upper-limit variable+the lower-limit variable)/2. In step 120, the priority index of the third program is set by the second program to equal the middle variable. In step 130, if the third program is run by the computer, the upper-limit variable is set to equal the middle variable and then the middle variable is set to equal a second outcome of computation according to the formula H; otherwise, the lower-limit variable is set by the second program to equal the middle variable and then the middle variable is set to equal the second outcome. In step 140, the steps 120 and 130 are repeated until the difference between the upper-limit and middle variables satisfies a predetermined condition. Finally in step 150, the value of the middle variable is outputted for the computer users.

The inspection method 100 of the embodiment can be implemented by means of computer software, in which the data type for priority indices of the application programs is often of integer. In the foregoing steps 110 and 130, the computational outcome of the formula H=(the upper-limit variable+the lower-limit variable)/2 can be not of integer, so the non-integer outcome can be rounded down by truncating its decimal component. Thereby the priority index can have its value kept in the data type of integer during the whole process of the method. But the present invention is not limited thereby, the priority index can keep its integer value by rounding up or rounding to nearest, or the middle variable can be in the data type of fixed-point number.

Considering the operating system VxWorks, the priority index is a variable of integer type with 1 byte or 8 bits which can encode 2⁸ numbers. In an embodiment, the priority index can be assigned from M=1 to N=255, and a program with a smaller priority index can be run by the computer system prior to that with a larger one. In other words, a program with priority index of M=1 has higher priority than that of N=255. Thus, “the third program is run by the computer” in the step 130 means that the third program has a higher priority than the first program, so that the second program can set the upper-limit variable equaling the middle variable and then the middle variable equaling the second outcome through the computation of formula H, so as to increase the priority index's value of the third program. On the other hand, if the third program is not run by the computer, it means that the third program has a lower priority than the first program, so that the second program can set the lower-limit variable equaling the middle variable and then the middle variable equaling the second outcome, so as to decrease the priority index's value of the third program. Consequently, the step 130 can either increase or decrease the priority index's value of the third program.

Further, by repeating the steps 120 and 130 as set forth in the step 140, the priority index's value of the third program can approach that of the first program gradually. Once the upper-limit or lower-limit variable is equal to the middle variable, the inspection method 100 according to the embodiment can have gotten the priority index's value of the first program. For the VxWorks operating system, the foregoing judgment condition can be that if the upper-limit variable is equal to the middle variable. Thus, the steps 120 and 130 are run no more, and the method can go forward to the step 150 to output the value of the middle variable as the priority index's value of the first program for the computer or its user. The computer system or its user can then match the program with the priority index's value; thereby, the troublemaker program or procedure can be found out to facilitate debugging the program.

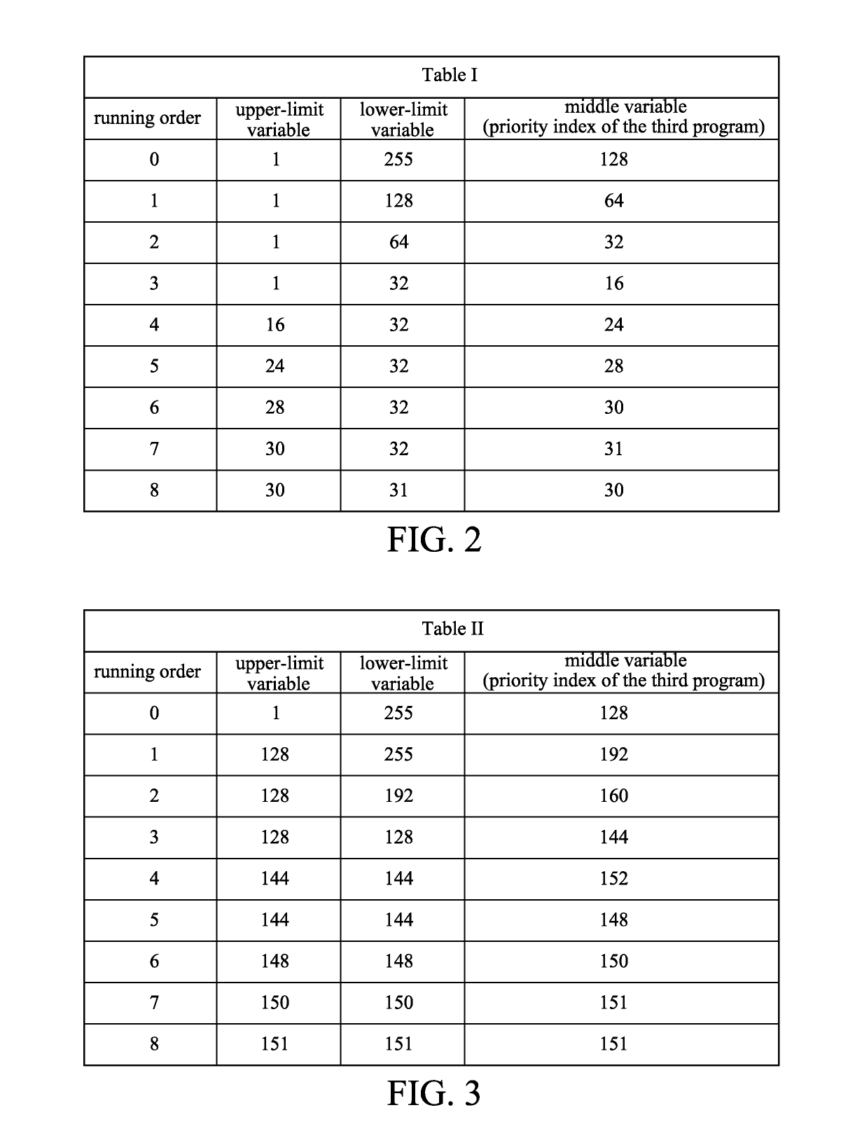

To explain in more detail, two examples are provided in the following. In the first example, a computer of VxWorks system is assumed to be deadlocked, due to overloading caused by a troublemaker program with its priority index being 30. Through the inspection method according to the embodiment, the upper-limit, middle, and lower-limit variables can be set by the second program as set forth in the steps 120 and 130, and summarized in Table I as shown in FIG. 2. The values of the variables are listed in rows according to running order of the steps 120 and 130, wherein the middle variable represents the priority index's value of the third program.

As shown in Table I, the priority index's value of the third program is 128 at the very beginning stage, and is decreased and then increased to reach the target 30 gradually. After the steps 120 and 130 have been run for eight times, the upper-limit variable is equal to the middle variable. As a consequence, the priority index's value of the troublemaker program can be found out in this example.

In the other example, a computer of VxWorks system is assumed to be deadlocked, due to overloading caused by another troublemaker program with its priority index being 151. Through the inspection method according to the embodiment, the upper-limit, middle, and lower-limit variables can be set by the second program as set forth in the steps 120 and 130, and summarized in Table II as shown in FIG. 3. The values of the variables are listed in rows according to running order of the steps 120 and 130, wherein the middle variable represents the priority index's value of the third program. As shown in Table II, the priority index's value of the third program is 128 in the beginning, and is increased and then decreased to reach the target 151 gradually. After the steps 120 and 130 have been run for eight times, the upper-limit variable is equal to the middle variable. As a consequence, the priority index's value of the troublemaker program can also be found out in this example.

The priority index can also be of non-integer number rather than of integer; for example, a fixed-point or floating-point number. Regarding an operating system in which the priority index can be declared or assigned to have its data type of floating-point variable, the priority index can be assigned from M=1 to N=255 in an embodiment, and a program with a smaller priority index can be run by the computer system prior to that with a larger one. In the inspection method 100 according to the embodiment, the middle variable can be set to be equal to the computation outcome of (the upper-limit variable+the lower-limit variable)/2 in the steps 110 and 130. Thus, “the third program is run by the computer” in the step 130 means that the third program has a higher priority than the first program, so that the second program can set the upper-limit variable equaling the middle variable and then the middle variable equaling (the upper-limit variable+the lower-limit variable)/2, so as to increase the priority index's value of the third program. On the other hand, if the third program is not run by the computer, it means that the third program has a lower priority than the first program, so that the second program can set the lower-limit variable equaling (the upper-limit variable+the lower-limit variable)/2, so as to decrease the priority index's value of the third program. Consequently, the step 130 can also either increase or decrease the priority index's value of the third program.

By repeating the steps 120 and 130 as set forth in the step 140, the priority index's value of the third program can approach that of the first program gradually. Once the difference between the upper-limit and middle variables satisfies a predetermined condition in which the upper-limit variable is substantially equal to the middle variable, the inspection method 100 can have gotten the priority index's value of the first program. Thus, the method will run the steps 120 and 130 no more, and can proceed with the step 150 to output the value of the middle variable as the priority index's value of the first program for the computer or its user. The computer system or its user can then match the program with the priority index's value; thereby, the troublemaker program or procedure can be found out to facilitate debugging the program. The foregoing term “substantially equal” can mean that the difference between the upper-limit and middle variables is less than or equal to a first predetermined value (for example, 0.5, but is not limited thereby), to facilitate obtaining the value of the priority index. On the other aspect, if a program with a larger priority index can be run by the computer, in another operating system, prior to that with a smaller one, the judgment condition can be “the difference between the lower-limit and middle variables satisfies a predetermined condition” instead.

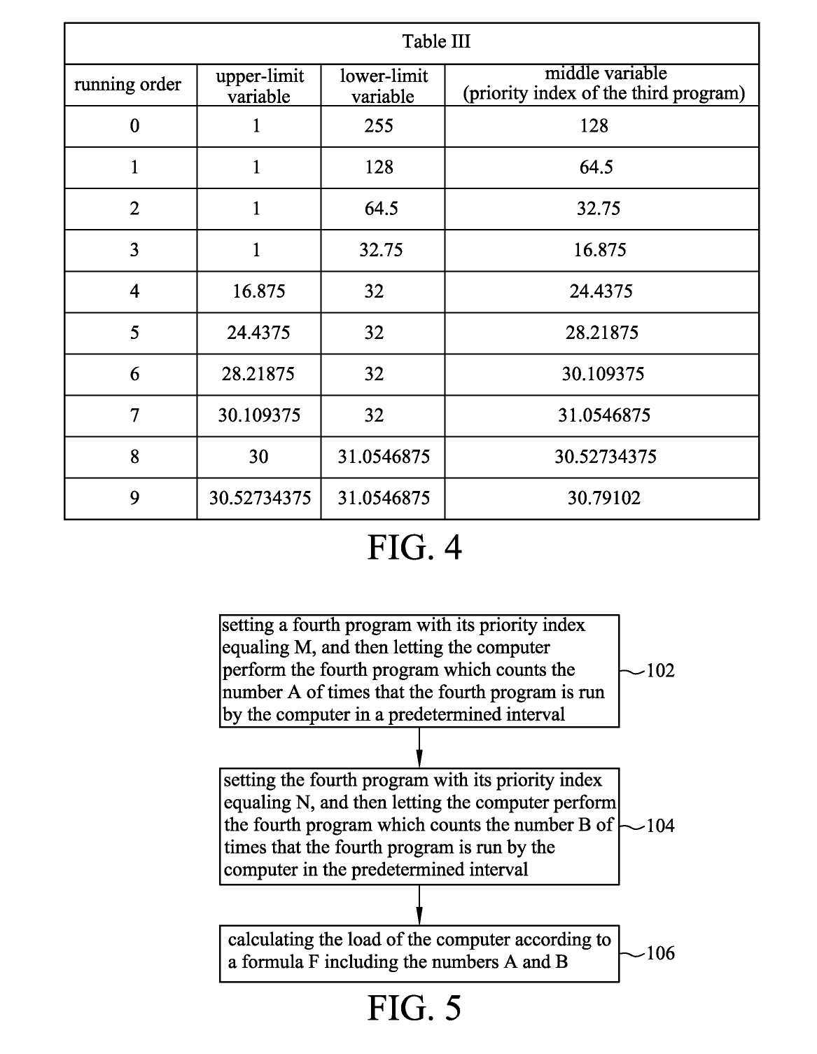

Below is an example for more detailed explanation. A computer is assumed to be deadlocked, due to overloading caused by a troublemaker program with its priority index being 31. Through the inspection method according to the embodiment, the upper-limit, middle, and lower-limit variables can be set by the second program as set forth in the steps 120 and 130, and summarized in Table III as shown in FIG. 4. The values of the variables are listed in rows according to running order of the steps 120 and 130, wherein the middle variable represents the priority index's value of the third program. As shown in Table III, the priority index's value of the third program is 128 in the beginning, and is decreased and then increased to reach the target 31 gradually. After the steps 120 and 130 have been run for nine times, the difference between the upper-limit and middle variables is less than 0.5. As a consequence, the priority index's value of the troublemaker program can be found out in this example.

Moreover, to confirm whether the computer is overloading or not, the inspection method 100 of the embodiment can further include steps of calculating the load of the computer. If the computer is judged being overloaded, the steps 110 to 150 can be performed to try to search the troublemaker program. To calculate the computer's load, a counter program is configured to count the times it is run. For sake of convenience in describing the embodiment, the counter program is also referred to as “forth program”. FIG. 5 shows a flowchart of a load calculating method according to an embodiment of the present invention. The calculating method includes the following steps. In step 102, the priority index of the fourth program is set to equal M, and then the fourth program is performed by the computer to count the number A of times that the fourth program is run in a predetermined interval. In step 104, the priority index of the fourth program is set to equal N, and then the fourth program is performed by the computer to count the number B of times that the fourth program is run in the predetermined interval. And in step 106, the load of the computer is calculated according to a formula F including the numbers A and B.

In a case that the operating system allows a program with a smaller priority index be run prior to that with a larger one, the forth program can include a counting parameter and program codes for counting. At first, in the step 102, the priority index of the fourth program is set to be M, the priority-index value with highest priority; for example, M is equal to 1 as set forth in the foregoing embodiments. The computer will run the forth program first due to its highest priority. Every time the forth program is run, the number of the counting parameter will be added by 1. After the predetermined interval, such as 1 second or less, the number of times will be denoted as A. Then in the step 104, the priority index of the fourth program is set to be N, the priority-index value with lowest priority; for example, N is equal to 255 as set forth in the foregoing embodiments. The computer is supposed to not run the forth program due to its lowest priority. However, every time the forth program is run, the number of the counting parameter will be added by 1. After the same predetermined interval, the number of times will be denoted as B. At last, in the step 106, the load of the computer is calculated according to the formula F including the numbers A and B.

For example, the formula F can be ((A-B)/A)×100% as its loading percentage. If the loading percentage is more than a predetermined value, such as 95%, the inspection method 100 of the foregoing embodiments can be activated to find the troublemaker program. On the other hand, in case that the operating system allows a program with a larger priority index be run prior to that with a smaller one, the formula F of loading percentage can be ((B-A)/B)×100% instead, to indicate the loading state of the computer.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. An inspection method for assisting in search of a first program which causes overloading in a computer, where each of to-be-run programs is set with a priority index to indicate its priority order being run by the computer, the priority index has its value in the range from M to N, the inspection method comprising the steps of:
(A) providing a second program to set an upper-limit variable equaling M, a lower-limit variable equaling N, and a middle variable equaling a first outcome of computation according to a formula H=(the upper-limit variable+the lower-limit variable)/2;
(B) setting, by the second program, a third program with its priority index equaling the middle variable;
(C) setting, by the second program, the upper-limit variable equaling the middle variable and then the middle variable equaling a second outcome of computation according to the formula H, if the third program is run by the computer; otherwise, setting the lower-limit variable equaling the middle variable and then the middle variable equaling the second outcome;
(D) repeating the steps (B) and (C), until the difference between the upper-limit or lower-limit variable and the middle variable satisfies a first predetermined value; and
(E) outputting the value of the middle variable.

2. The inspection method of claim 1, further comprising the steps of:
calculating the load of the computer; and
performing the steps (A) to (E) if the computer is overloaded.

3. The inspection method of claim 2, wherein the step of calculating the load of the computer comprising the steps of:
setting a fourth program with its priority index equaling M, and then letting the computer perform the fourth program which counts the number A of times that the fourth program is run by the computer in a predetermined interval;
setting the fourth program with its priority index equaling N, and then letting the computer perform the fourth program which counts the number B of times that the fourth program is run by the computer in the predetermined interval; and
calculating the load of the computer according to a formula F including the numbers A and B.

4. The inspection method of claim 3, wherein the formula F is ((A-B)/A)×100% if a program with priority index of M has higher priority than that of N, while the formula F is ((B-A)/B)×100% if a program with priority index of M has lower priority than that of N.

5. The inspection method of claim 4, wherein the overload of the computer includes a condition that the calculated load of the computer is more than a second predetermined value.

6. The inspection method of claim 1, wherein M equals 1 and N equals 255.

7. The inspection method of claim 1, wherein the step (D) is to repeat the steps (B) and (C) until the difference between the upper-limit and middle variables satisfies the first predetermined value, if a program with priority index of M has higher priority than that of N.

8. The inspection method of claim 1, wherein the first predetermined value is less than or equal to 0.5.

9. An inspection method for assisting in search of a troublemaker program which causes overloading in a computer, where each of to-be-run programs is set with a priority index to indicate its priority order being run by the computer, the priority index has its value in the range from M to N, the inspection method comprising the steps of:
(A) setting a first program with its priority index equaling M, and then letting the computer perform the first program which counts the number A of times that the first program is run by the computer in a predetermined interval;
(B) setting the first program with its priority index equaling N, and then letting the computer perform the first program which counts the number B of times that the first program is run by the computer in the predetermined interval;
(C) calculating the load of the computer according to a formula F including the numbers A and B;
(D) providing a second program to set an upper-limit variable equaling M, a lower-limit variable equaling N, and a middle variable equaling a first outcome of computation according to a formula H=(the upper-limit variable+the lower-limit variable)/2;
(E) setting, by the second program, a third program with its priority index equaling the middle variable;
(F) setting, by the second program, the upper-limit variable equaling the middle variable and then the middle variable equaling a second outcome of computation according to the formula H, if the third program is run by the computer; otherwise, setting the lower-limit variable equaling the middle variable and then the middle variable equaling the second outcome;
(G) repeating the steps (E) and (F), until the difference between the upper-limit or lower-limit variable and the middle variable satisfies a first predetermined value; and
(H) outputting the value of the middle variable.

10. The inspection method of claim 9, wherein the formula F is ((A-B)/A)×100% if a program with priority index of M has higher priority than that of N, while the formula F is ((B-A)/B)×100% if a program with priority index of M has lower priority than that of N.

11. The inspection method of claim 9, wherein M equals 1 and N equals 255.

12. The inspection method of claim 9, wherein the step (G) is to repeat the steps (E) and (F) until the difference between the upper-limit and middle variables satisfies the first predetermined value, if a program with priority index of M has higher priority than that of N.

13. The inspection method of claim 9, wherein the first predetermined value is less than or equal to 0.5.
